(19) United States
(12) Patent Application Publication
(10) Pub. No.: US 2025/0044878 A1
(43) Pub. Date: Feb. 6, 2025

(54) MAGNETIC MEASUREMENTS USING INDUCTANCE MEASUREMENTS

(71) Applicant: AZOTEQ HOLDINGS LIMITED, Nicosia (CY)

(72) Inventors: Frederick Johannes BRUWER, Paarl (ZA); Daniël Barend RADEMEYER, Paarl (ZA)

(21) Appl. No.: 18/791,728

(22) Filed: Aug. 1, 2024

(30) Foreign Application Priority Data
Aug. 1, 2023 (ZA) 2023/07604

(51) Int. Cl. G06F 3/02; G01D 5/20; H01H 36/00

(52) U.S. Cl. CPC G06F 3/0202; G01D 5/20; H01H 36/0073

(57) ABSTRACT

The keys are fitted with small magnets and the movement of each key is detected and measured with inductive sensors that are adjacent to a ferrite member. The properties of the ferrite member change due to the proximity of the magnet, and these changes influence the inductive measurements. The ferrite member can be used to seal the electronics in a keyboard making it less prone to malfunction when coffee or other fluids are spilled onto it.

### CROSS-REFERENCE TO RELATED APPLICATION

The present application claims priority from South Africa applications ZA 2023/07604, filed Aug. 1, 2023, the content of which is hereby incorporated by reference into this application.

### BACKGROUND

Keyboards are standard peripherals for computers (e.g. laptops, notebooks, desktops etc.) The most common type is made with electromechanical switches that only indicate a single “make point” when ohmic contact happens. However, a newer generation keyboard offers keys with more information about, for example, the speed, force or depth with or to which a key is pressed.

Various technologies are used for example optical, magnetic/Hall effect combination or plunger/inductive.

Often the keyboard design is such that it is susceptible to damage or malfunction when exposed to fluids such as for example coffee, sodas or juice.

### SUMMARY OF THE INVENTION

A key structure (switch) is proposed for a use in keypads or keyboards wherein a moving member is fitted with a magnet. As the user presses the key, the moving member will propel the magnet in the direction of the press (typically downwards). Instead of the normal Hall effect type sensor underneath the switch to measure the magnetic field strength and thus derive the distance, it is proposed to use an inductive sensor and a ferrite cover that is adjacent to the said inductor.

The inductive sensor is linked to an inductor that is positioned directly below the key (on the axis of key movement). The inductor, that may be formed on a printed circuit board (pcb), is covered with a ferrite member that actually increases the inductance of the inductor. Thus, the inductance is indicative of the distance between the magnet and the combination.

However, as the magnet gradually approaches the inductor/ferrite combination, the ferrite properties are gradually influenced by the magnet and this, in turn, gradually influences the measured inductance of the inductor.

Unlike the magnetic field measurement implementation that requires a sensor (e.g. Hall effect IC) under every key, a single IC may be able to measure multiple inductors that are positioned under every key in the key pad or keyboard i.e. an inductor per key but multiple inductors measured by a single IC.

The key may be, for example, a GATERON (KS-20 Magnetic) and the ferrite member may be a ferrite layer such as supplied by 3M™ (EMI Absorber AB5000HF Series).

By using the ferrite layer to cover the complete pcb and sealing it at the sides as part of the housing will help to make the system less prone to damage by fluid spills.

It is also a no-contact system that will have less wear and tear and will improve reliability when compared to ohmic contact switches.

If LED's are required per key or distributed over the keyboard, holes may be made in the ferrite layer and the holes may be sealed with a transparent material or the ferrite layer may be covered with a complete transparent sealing layer.

In another embodiment, ferrite layer modules may be used to cover only the inductor (for example—formed on the pcb) and all may be sealed with an additional layer of material or transparent conformal coating. Optionally a ferrite module may be inserted into the core of the inductor.

The invention provides a non-contact type switch (i.e. no ohmic contact required) that enables measurement of the distance the key switch is depressed by the user and, as such, also enables determination of the speed of depression. It is thus not only a matter of saturating the ferrite but in fact the ferrite properties are gradually changed as the magnet starts coming closer and this gradually affects the inductance measured to form an analogue impression of the actuation by the user.

The invention allows for sealing the electronics that are sensitive to fluids (e.g. coffee, sodas etc.) from the moving or exposed parts of the keyboard.

By using multiple inductors with ferrite cores placed adjacent to a rotating magnet, the inductance of two inductors can be measured and these measurements can be used to calculate the orientation of the magnet. In this way the rotation of, for example, a mouse wheel fitted with a magnet on its axis can be determined.

This implementation may have cost advantages when compared to multiple Hall sensors placed “off-axis” to get a better phase angle, and makes it possible to get a better phase angle than can be achieved with a single cost effective IC that offers multiple Hall plates.

### BRIEF DESCRIPTION OF DRAWINGS

FIG. 1—Magnetic/Inductive key structure: Shows the elements required for implementing the key.

FIG. 2—Magnetic/Inductive key with LED: Shows how to add a LED indicator to show when the key is activated or perform other visuals.

FIG. 3—PC keyboard stack up for using magnetic/inductive keys.

FIGS. 4a, 4b, 4c respectively show chip, coil and pcb inductors and various ferrites.

FIG. 5 shows an arrangement for rotational measurement, wherein two inductors with ferrite cores are placed in off-axis orientation. By measuring the inductance of the two inductors the rotation of the magnet can be determined.

### DETAILED DESCRIPTION OF THE INVENTION

The following description provides an understanding of the invention with reference to the accompanying drawings. The description is exemplary only and not exhaustive as other implementations of the invention exist which fall inside the scope of the claims.

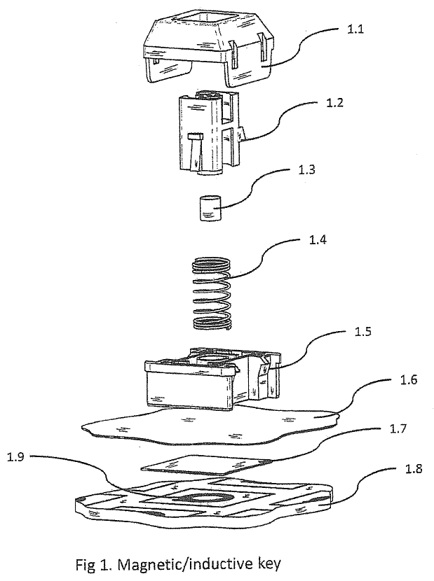

FIG. 1 illustrates a typical key structure that forms a component of a computer keyboard and is fitted with a magnet that moves up and down in accordance with the user actuation of the key.

The various parts fit together and a key cap is not shown. The key cover (1.1) is under the key cap (not shown) and fits over a press part (1.2) with the magnet (1.3) pressed into the press part. A spring (1.4) is used between a base (1.5) and the press part (1.2) to push the key back into the “open” position when the user releases the pressure on the key.

In this example of using the magnetic/inductive sensing technology for a keyboard, there is a motherboard or baseboard (1.8) on top of which all the keys are mounted. A pcb (1.8) may be used to form an inductor (1.9) in this example that is connected to an inductive measurement IC, on the motherboard, that is not shown.

In accordance with this invention a ferrite member (1.7) is placed on top of the coil. The ferrite member may also be a cylindrical core that is placed in the center of the coil or a combination of a layer and a cylindrical part.

As the magnet (1.3) comes closer to the ferrite member (1.7) and the inductor (1.9) combination the ferrite properties are affected by the magnetic flux and this changes the inductance in the inductor which is then measured. The degree of movement of the magnet relative to the coil is reflected in the inductive measurement.

A sealing layer (1.6) or conformal coating may be used to seal the pcb (1.8) and components from being affected by fluids. Sealing can also be achieved by using a single big sheet of ferrite (1.7) that covers the complete baseboard. The additional sealing layer (1.6) is then not used.

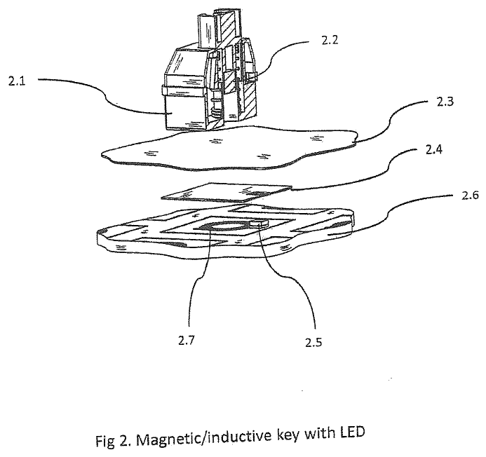

In FIG. 2 an LED (2.5) is added to the circuitry, said LED and switch components are designed to let a user see the light from the said LED. In accordance with this invention the ferrite layer (2.4) has a space for the LED to protrude through. The sealing layer (2.3), if required, must be transparent to let the LED light through.

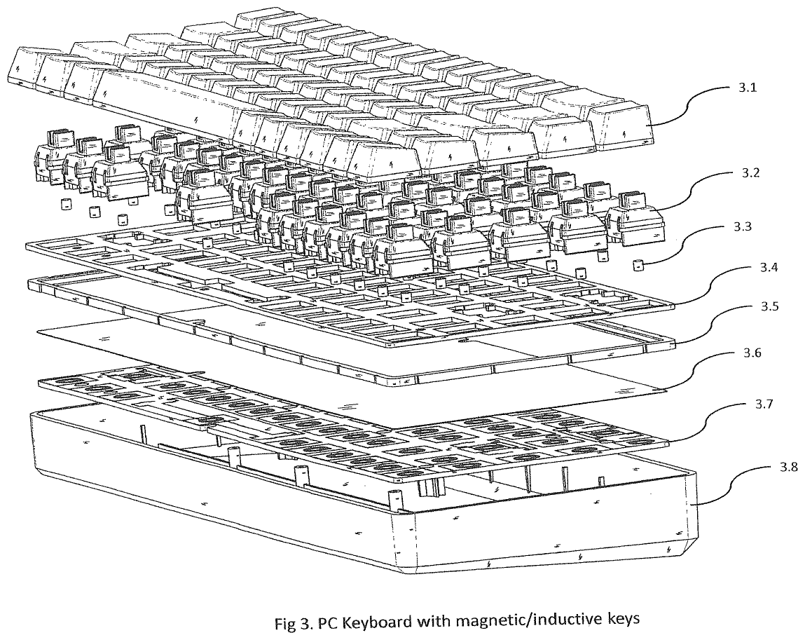

FIG. 3 depicts a typical stack up structure for a keyboard using the magnetic/inductive switch combination in accordance with this invention. For each switch a cap (3.1) is fitted on top of a switch mechanism (3.2) with a magnet (3.3) attached to a moving part of the switch (3.2). All of the switches are fitted into a frame (3.4) that positions and aligns the switches into the keyboard with reference to a pcb (3.7). In order to seal the pcb and all the electronics that are part of the pcb, a gasket or seal ring (3.5) is designed to be placed on top of the sealing layer (3.6) and the keyboard base (3.8) in order to prevent any fluids coming from the top to reach the pcb.

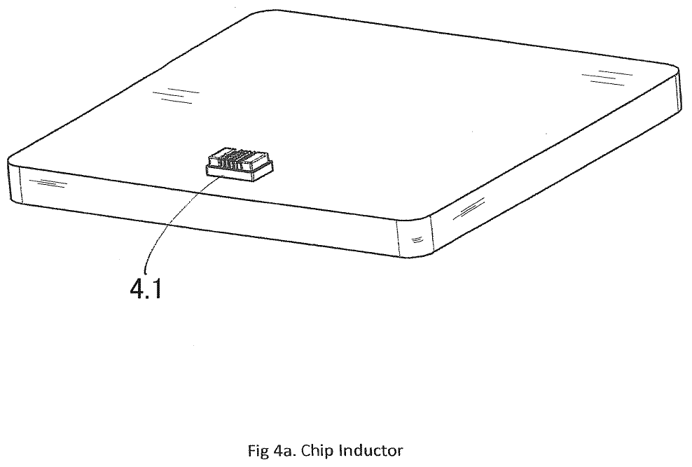

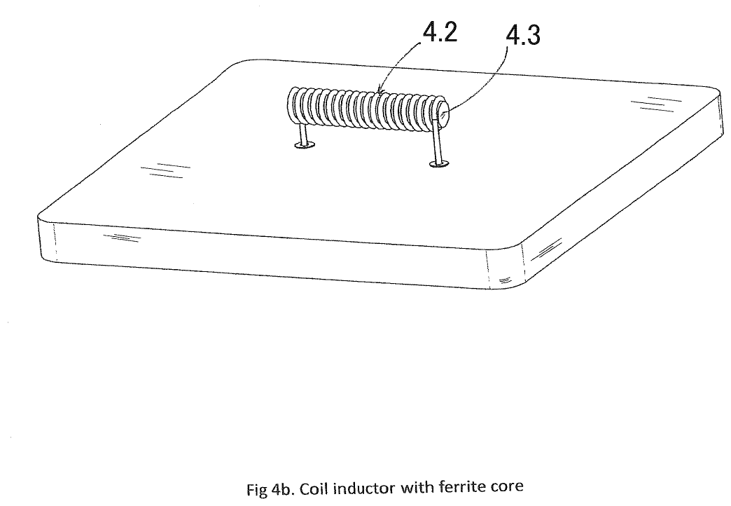

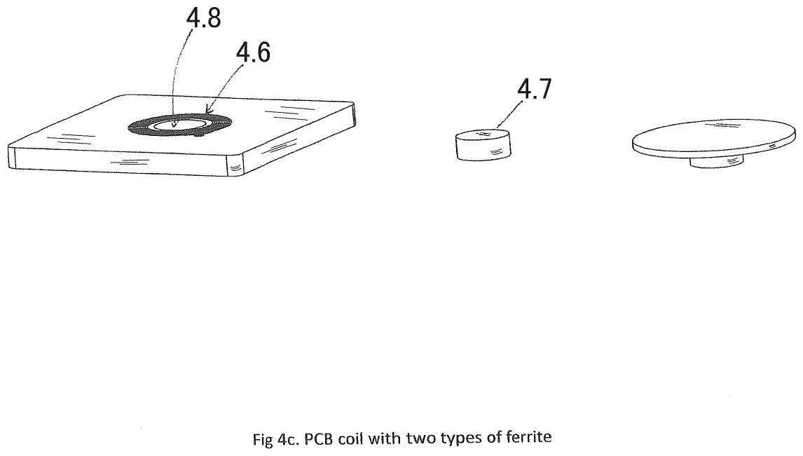

In FIG. 4 other types of inductors that may be used are shown. In FIG. 4a, the invention is implemented using a surface mount chip inductor (4.1). This may be convenient in applications with limited space.

In FIG. 4b a coil inductor (4.2) with a ferrite core (4.3) is used to implement the invention and the advantage may be placement that requires leads.

In FIG. 4c the implementation uses a pcb coil (4.6) and a ferrite (4.7) that is placed on top of the inductor and through the core (4.8) of the inductor.

In further embodiments the frame (3.4) may be attached to the base (3.8) in a way that it is removable without breaking the sealing to the pcb or other electronics below the sealing layer (3.6). This will allow the top parts to be removed and cleaned (e.g. rinsed with water) without affecting the bottom parts. This can also apply to an embodiment where the magnetic/inductive key implementation is part of a laptop or notebook computer.

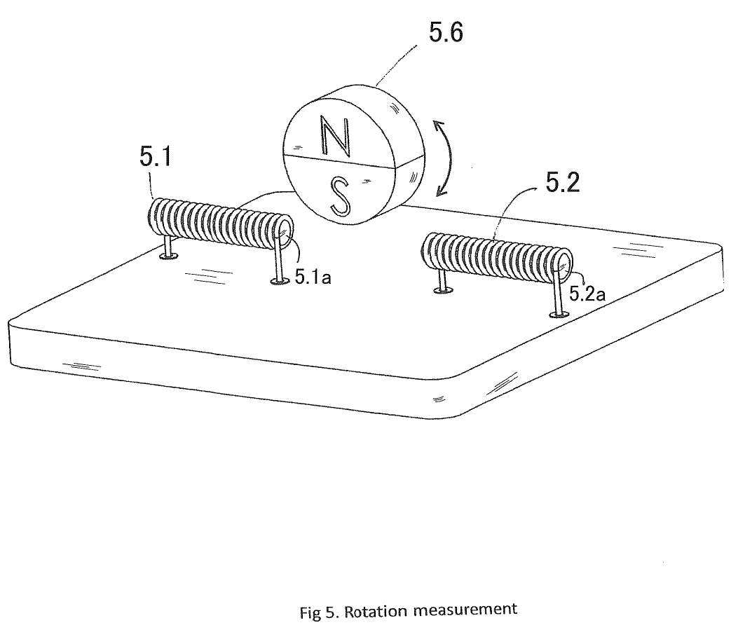

In a further embodiment the invention may be used to implement a rotational measurement system by placing two inductors (5.1, 5.2) with ferrite cores (5.1a, 5.2a) as per FIG. 5. The inductors may be placed to have a favourable phase angle in an off-axis position with regard to a magnet (5.6). This is difficult to achieve with a single Hall effect sensor IC due to the small dimensions of a typical (cost effective) IC.

1. A switch mechanism for determining multiple points of depression as a switch is actuated, said switch comprising a magnet that moves in response to depression of a key and an inductor/ferrite combination the inductance of which is measured, wherein said measured inductance reflects the distance between the said magnet and the said inductor/ferrite combination.

2. A method of implementing a non-ohmic contact switch by measuring the inductance of an inductor with a ferrite member adjacent to said inductor, said ferrite member being affected by a magnet being moved relative to the ferrite member under user actuation in such a way that the inductance measured in the inductor changes, and wherein said switch is configured to provide information about multiple points of said movement during user actuation.

3. A method of implementing a magnetic rotation sensor using multiple inductor and ferrite combination units placed near a magnet that is mounted on an axle to enable rotation, and wherein the measured changes in inductance of the inductors reflect the rotation of the magnet.

4. The method according to claim 2 which includes the steps of using multiple switches in a keyboard wherein each switch is implemented as per claim 2 and of positioning a sealing layer between moving parts of the keyboard and the inductors of the switches.

5. The switch mechanism of claim 1 wherein said combination comprises a ferrite member adjacent a coil of an inductor which is located on a pcb and said pcb is sealed by means of a sealing layer or by said ferrite member which is provided as a sheet of ferrite.

6. The switch mechanism of claim 1 which includes an LED and wherein the ferrite in said combination comprises a ferrite layer through which the LED protrudes.

7. A switch mechanism which comprises a pcb, an inductor on the pcb, a ferrite member which overlies a coil of the inductor, a spring, a magnet which is movable by a user against action of the spring towards the coil and wherein the ferrite member and inductor are configured such that flux from the magnet affects properties of the ferrite which produce a change in the measured inductance of the inductor.
